(19) United States
(12) Patent Application Publication
(10) Pub. No.: US 2022/0270195 A1
(43) Pub. Date: Aug. 25, 2022

(54) Identity Verification System and Method

(71) Applicant: b-rad Design LLC, Concord, MA (US)

(72) Inventor: Bradley Moriarty, Concord, MA (US)

(21) Appl. No.: 17/677,567

(22) Filed: Feb. 22, 2022

Related U.S. Application Data
(60) Provisional application No. 63/151,349, filed on Feb. 19, 2021.

(51) Int. Cl. G06Q 50/26; G06Q 50/00

(52) U.S. Cl. CPC G06Q 50/265; G06Q 50/01

(57) ABSTRACT

A computer-implemented method, computer program product and computing system for defining a plurality of identity verification parties for a user; and engaging each of the plurality of identity verification parities to generate at least one verification item for the user, thus defining a plurality of verification items; wherein the plurality of verification items are configured to enable the verification of the identity of the user.

### RELATED APPLICATION(S)

This application claims the benefit of U.S. Provisional Application No. 63/151,349 filed on 19 Feb. 2021, the entire contents of which are incorporated herein by reference.

### TECHNICAL FIELD

This disclosure relates to verification systems and methods and, more particularly, to identity verification systems and methods.

### BACKGROUND

Identity theft protection is an $8.6 billion dollar market (2019-Research & Markets), the overwhelming majority of the market being made up of credit monitoring and other products designed to flag indicators that unauthorized access has already occurred.

Essentially, current identity theft protection only tells you after your identity has been compromised. You just have to hope that you can take remedial action in time. The ideal form of identity theft prevention makes it impossible for someone other than the individual subject to use his/her/their identity.

Identity verification is often accomplished by asking questions that only the individual subject should know. However, the data that is used to formulate those questions typically comes from financial data and real estate transactions that are widely available to banks and other financial institutions and the data is often not familiar to the individual subject, so identification can fail or be compromised by those with access to the underlying data.

### SUMMARY OF DISCLOSURE

In one implementation, computer-implemented method is executed on a computing device and includes: defining a plurality of identity verification parties for a user; and engaging each of the plurality of identity verification parities to generate at least one verification item for the user, thus defining a plurality of verification items; wherein the plurality of verification items are configured to enable the verification of the identity of the user.

One or more of the following features may be included. The plurality of identity verification parties may be associated with the user via a social network. The plurality of identity verification parties may be associated with the user via a communication program. The plurality of identity verification parties may be members of two or more verification groups. The plurality of verification items may include one or more of: at least one question & answer pair; at least one image item & answer pair; at least one video item & answer pair; and at least one audio item & answer pair. The user may become a member of an identity verification platform upon engaging a minimum-required number of identity verification parities and/or generating a minimum-required number of verification items for the user. One or more financial institutions may be notified that the user is a member of the identity verification platform and that the one or more financial institutions should only verify the identity of the user (if the need arises) via the identity verification platform. The identity of the user may be verified via one or more of the plurality of verification items. The computer-implemented method of claim 8 wherein verifying the identity of the user includes one or more of: requiring the user to select an answer to a question & answer pair; requiring the user to select an answer to an image item & answer pair; requiring the user to select an answer to a video item & answer pair; and requiring the user to select an answer to an audio item & answer pair; requiring the user to select a question to a question & answer pair; requiring the user to select an image item to an image item & answer pair; requiring the user to select a video item to a video item & answer pair; and requiring the user to select an audio item to an audio item & answer pair. Verifying the identity of the user may include one or more of: requiring the user to provide an answer to a question & answer pair; requiring the user to provide an answer to an image item & answer pair; requiring the user to provide an answer to a video item & answer pair; and requiring the user to provide an answer to an audio item & answer pair.

In another implementation, a computer program product resides on a computer readable medium and has a plurality of instructions stored on it. When executed by a processor, the instructions cause the processor to perform operations including defining a plurality of identity verification parties for a user; and engaging each of the plurality of identity verification parities to generate at least one verification item for the user, thus defining a plurality of verification items; wherein the plurality of verification items are configured to enable the verification of the identity of the user.

One or more of the following features may be included. The plurality of identity verification parties may be associated with the user via a social network. The plurality of identity verification parties may be associated with the user via a communication program. The plurality of identity verification parties may be members of two or more verification groups. The plurality of verification items may include one or more of: at least one question & answer pair; at least one image item & answer pair; at least one video item & answer pair; and at least one audio item & answer pair. The user may become a member of an identity verification platform upon engaging a minimum-required number of identity verification parities and/or generating a minimum-required number of verification items for the user. One or more financial institutions may be notified that the user is a member of the identity verification platform and that the one or more financial institutions should only verify the identity of the user (if the need arises) via the identity verification platform. The identity of the user may be verified via one or more of the plurality of verification items. The computer-implemented method of claim 8 wherein verifying the identity of the user includes one or more of: requiring the user to select an answer to a question & answer pair; requiring the user to select an answer to an image item & answer pair; requiring the user to select an answer to a video item & answer pair; and requiring the user to select an answer to an audio item & answer pair; requiring the user to select a question to a question & answer pair; requiring the user to select an image item to an image item & answer pair; requiring the user to select a video item to a video item & answer pair; and requiring the user to select an audio item to an audio item & answer pair. Verifying the identity of the user may include one or more of: requiring the user to provide an answer to a question & answer pair; requiring the user to provide an answer to an image item & answer pair; requiring the user to provide an answer to a video item & answer pair; and requiring the user to provide an answer to an audio item & answer pair.

In another implementation, a computing system includes a processor and a memory system configured to perform operations including defining a plurality of identity verification parties for a user; and engaging each of the plurality of identity verification parities to generate at least one verification item for the user, thus defining a plurality of verification items; wherein the plurality of verification items are configured to enable the verification of the identity of the user.

One or more of the following features may be included. The plurality of identity verification parties may be associated with the user via a social network. The plurality of identity verification parties may be associated with the user via a communication program. The plurality of identity verification parties may be members of two or more verification groups. The plurality of verification items may include one or more of: at least one question & answer pair; at least one image item & answer pair; at least one video item & answer pair; and at least one audio item & answer pair. The user may become a member of an identity verification platform upon engaging a minimum-required number of identity verification parities and/or generating a minimum-required number of verification items for the user. One or more financial institutions may be notified that the user is a member of the identity verification platform and that the one or more financial institutions should only verify the identity of the user (if the need arises) via the identity verification platform. The identity of the user may be verified via one or more of the plurality of verification items. The computer-implemented method of claim 8 wherein verifying the identity of the user includes one or more of: requiring the user to select an answer to a question & answer pair; requiring the user to select an answer to an image item & answer pair; requiring the user to select an answer to a video item & answer pair; and requiring the user to select an answer to an audio item & answer pair; requiring the user to select a question to a question & answer pair; requiring the user to select an image item to an image item & answer pair; requiring the user to select a video item to a video item & answer pair; and requiring the user to select an audio item to an audio item & answer pair. Verifying the identity of the user may include one or more of: requiring the user to provide an answer to a question & answer pair; requiring the user to provide an answer to an image item & answer pair; requiring the user to provide an answer to a video item & answer pair; and requiring the user to provide an answer to an audio item & answer pair.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an identity verification process according to an embodiment of the present disclosure;

FIG. 2 is a flowchart of the identity verification process of FIG. 1 according to an embodiment of the present disclosure; and

FIG. 3 is a diagrammatic view of the identity verification process of FIG. 1 interacting with a social network according to an embodiment of the present disclosure.

Like reference symbols in the various drawings indicate like elements.

### DETAILED DESCRIPTION OF THE PREFERRED EMBODIMENTS

System Overview

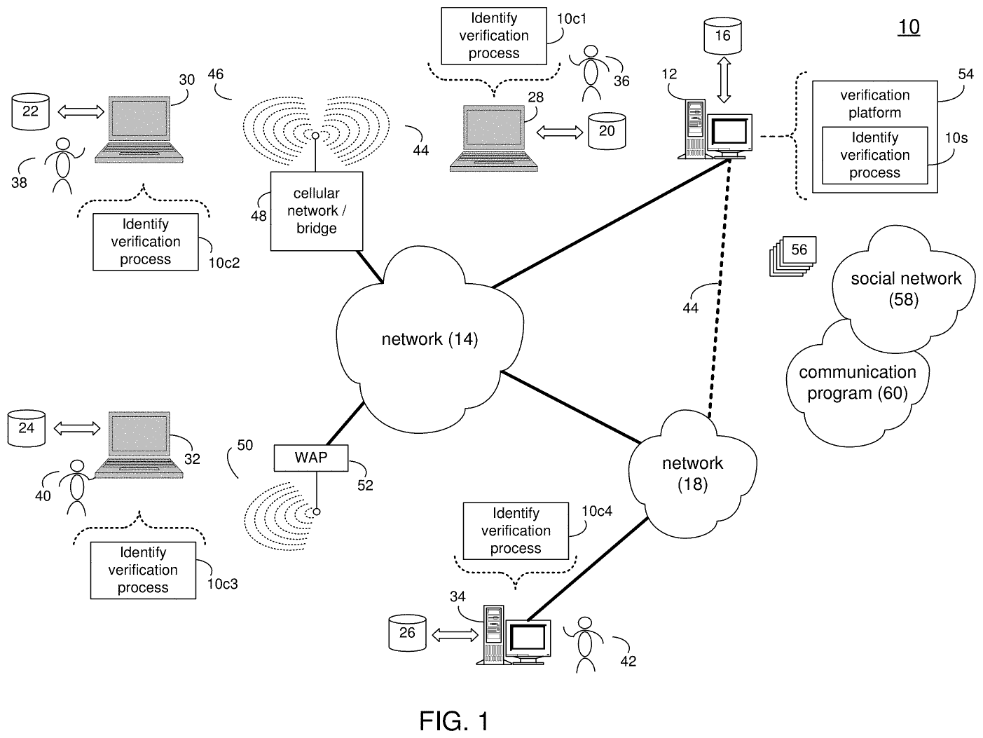

Referring to FIG. 1, there is shown identity verification process 10. Identity verification process 10 may be implemented as a server-side process, a client-side process, or a hybrid server-side/client-side process. For example, identity verification process 10 may be implemented as a purely server-side process via identity verification process 10s. Alternatively, identity verification process 10 may be implemented as a purely client-side process via one or more of identity verification process 10c1, identity verification process 10c2, identity verification process 10c3, and identity verification process 10c4. Alternatively still, identity verification process 10 may be implemented as a hybrid server-side/client-side process via identity verification process 10s in combination with one or more of identity verification process 10c1, identity verification process 10c2, identity verification process 10c3, and identity verification process 10c4. Accordingly, identity verification process 10 as used in this disclosure may include any combination of identity verification process 10s, identity verification process 10c1, identity verification process 10c2, identity verification process 10c3, and identity verification process 10c4.

Identity verification process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, a smartphone, or a cloud-based computing platform.

The instruction sets and subroutines of identity verification process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random-access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of identity verification processes 10c1, 10c2, 10c3, 10c4 may include but are not limited to a web browser, a game console user interface, a mobile device user interface, or a specialized application (e.g., an application running on e.g., the Android™ platform, the iOS™ platform, the Windows™ platform, the Linux™ platform or the UNIX™ platform). The instruction sets and subroutines of identity verification process es 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to, a smartphone (not shown), a personal digital assistant (not shown), a tablet computer (not shown), laptop computers 28, 30, 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, iOS™, Linux™, or a custom operating system.

Users 36, 38, 40, 42 may access identity verification process 10 directly through network 14 or through secondary network 18. Further, identity verification process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, laptop computer 28 and laptop computer 30 are shown wirelessly coupled to network 14 via wireless communication channels 44, 46 (respectively) established between laptop computers 28, 30 (respectively) and cellular network/bridge 48, which is shown directly coupled to network 14. Further, laptop computer 32 is shown wirelessly coupled to network 14 via wireless communication channel 50 established between laptop computer 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between laptop computer 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

Identity Verification Process

Assume for illustrative purposes that user 36 wishes to utilize verification platform 54 to verify their identity. As stated above, identity theft is a massive problem, wherein a scammer may pretend to be a third-party so that they may e.g., take out loans, obtain credit cards, make purchases and/or incur debt in the name of that third party. What further complicates the situation is that the traditional manner in which the identity of a user is confirmed is through the use of “security questions” that have been defined from generally/essentially publicly available data (e.g., the name of your elementary school, the name of your high school, your first employer, the name of your father, etc.).

As will be discussed below in greater detail, verification platform 54 may utilize/effectuate all or some of identity verification process 10 to generate bespoke verification items (e.g., verification items 56) for the user (e.g., user 36) that may be subsequently utilized to verify the identity the user (e.g., user 36).

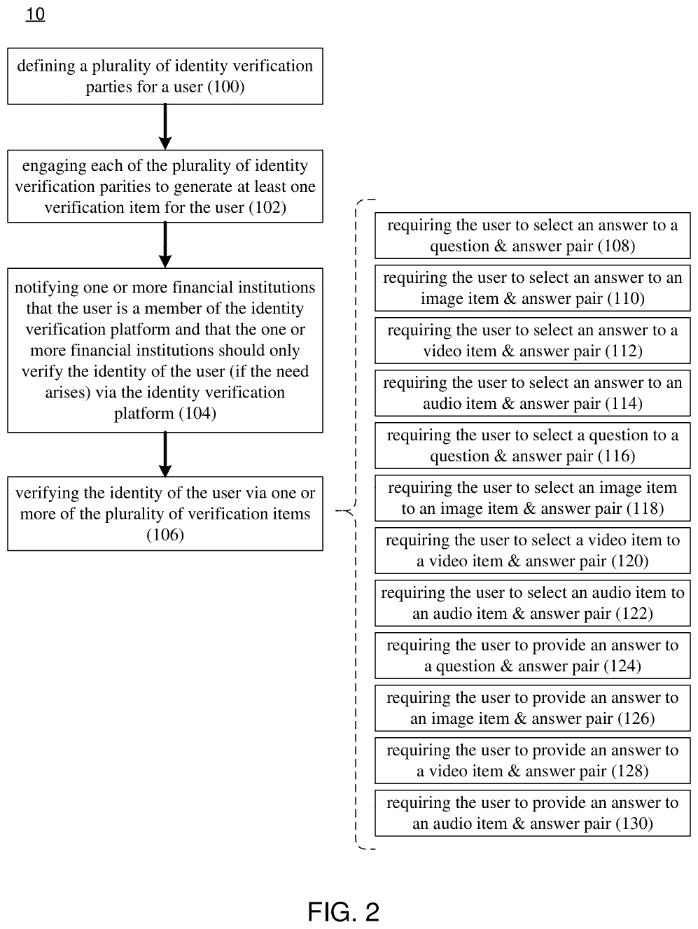

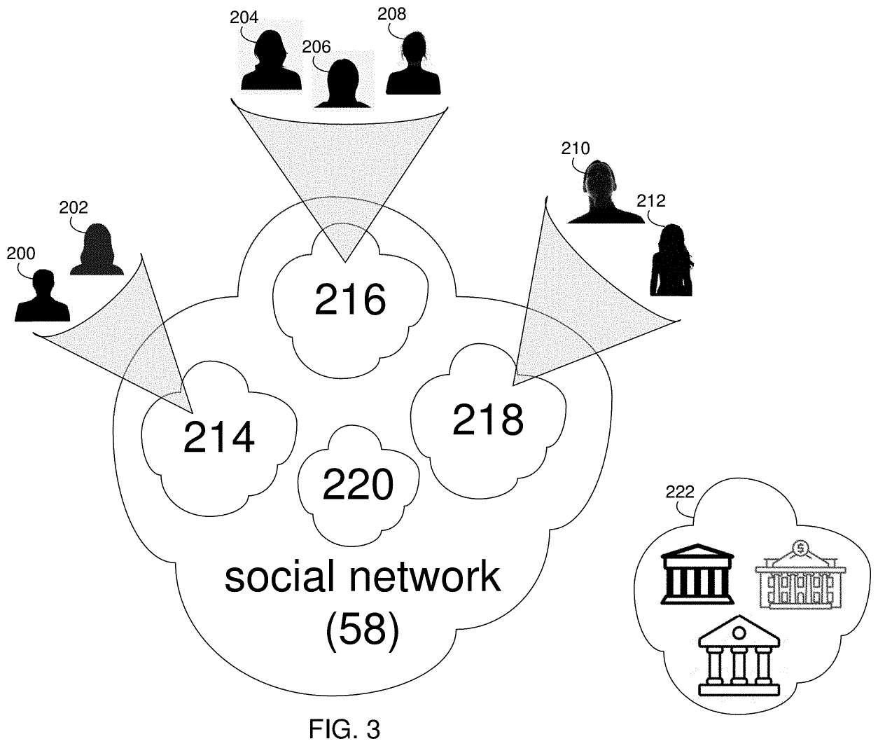

Referring also to FIGS. 2-3, identity verification process 10 may define 100 a plurality of identity verification parties (e.g., identity verification parties 200, 202, 204, 206, 208, 210, 212) for a user (e.g., user 36). While for the following discussion, the plurality of identity verification parties (e.g., identity verification parties 200, 202, 204, 206, 208, 210, 212) may be associated with the user (e.g., user 36) via a social network (e.g., social network 58), this is for illustrative purposes only and is not intended to be a limitation of this disclosure, as other configurations are possible and are considered to be within the scope of this disclosure. For example, the plurality of identity verification parties (e.g., identity verification parties 200, 202, 204, 206, 208, 210, 212) may be associated with the user (e.g., user 36) via a communication program (e.g., communication program 60), examples of which may include but are not limited to an email program or a contact management program. Generally speaking, any platform (e.g., social network 58, communication program 60, or any other type of program/platform) in which a user (e.g., user 36) has established relationships with other people may serve as a source for the identity verification parties (e.g., identity verification parties 200, 202, 204, 206, 208, 210, 212). Identity verification process 10 and/or verification platform 54 may be included within (or a portion of) social network 58/communication program 60. Additionally/alternatively, identity verification process 10 and/or verification platform 54 may be stand-alone entities.

The plurality of identity verification parties 200, 202, 204, 206, 208, 210, 212 may be members of two or more verification groups (e.g., verification groups 214. 216. 218). Generally speaking, people tend to have different groups of friends/colleagues. For example, user 36 may have a first group of friends/colleagues from their days in high school, a second group of friends/colleagues from their days in college, a third group of friends/colleagues from their days of living on the West Coast of the United States, and a fourth group of friends/colleagues from their days of living on the East Coast of the United States. Additionally and as would be expected, each of these different groups of friends/colleagues may not overlap and may have different sets of knowledge respect to (in this example) user 36.

For example:
only a first group of friends/colleagues from the days that user 36 was in high school may have knowledge of e.g., high school nicknames, high school class trips, high school proms, and high school romances for user 36.
only a second group of friends/colleagues from the days that user 36 was in college may have knowledge of e.g., college nicknames, college job fairs, college fraternities, and college romances for user 36.
only a third group of friends/colleagues from the days that user 36 was living on the West Coast of the United States may have knowledge of e.g., West Coast bars/restaurants/clubs, West Coast hiking trails, West Coast amusement parks, and West Coast romances for user 36,
only a fourth group of friends/colleagues from the days that user 36 was living on the East Coast of the United States may have knowledge of e.g., East Coast bars/restaurants/clubs, East Coast jobs, East Coast trips, and East Coast romances for user 36.

Accordingly and by using identity verification parties (e.g., identity verification parties 200, 202, 204, 206, 208, 210, 212) from multiple verification groups (e.g., verification groups 214. 216. 218), any verification items (e.g., verification items 56) generated may be more diverse and, therefore, may provide for a more robust verification of the identity of user 36 (as will be discussed below).

Once defined 100, identity verification process 10 may engage 102 each of the plurality of identity verification parties (e.g., each of identity verification parties 200, 202, 204, 206, 208, 210, 212) to generate at least one verification item for the user (e.g., user 36), thus defining a plurality of verification items (e.g., verification items 56). As will be discussed below in greater detail, the plurality of verification items (e.g., verification items 56) may be configured to enable the verification of the identity of the user (e.g., user 36).

While the following discussion will concern identity verification parties 200, 202, 204, 206, 208, 210, 212 being selected from the friends of user 36 defined within social network 58, this is for illustrative purposes only and it is understood that other platforms (e.g., communication platform 60) may be utilized to define 100 identity verification parties 200, 202, 204, 206, 208, 210, 212.

Continuing with the above-stated example in which user 36 wishes to utilize verification platform 54 to verify their identity, user 36 may define 100 the plurality of identity verification parties (e.g., identity verification parties 200, 202, 204, 206, 208, 210, 212) by selecting individuals from their friend group (e.g., friend group 220) within (in this example) social network 58.

Assume that user 36 uses identity verification process 10 to define 100 the plurality of identity verification parties 200, 202, 204, 206, 208, 210, 212) from three verification groups (e.g., verification groups 214. 216. 218), wherein:
identity verification parties 200, 202 are members of verification group 214 (e.g., a group of high school friends) and are, therefore, well-suited for defining one or more verification items (e.g., included within verification items 56) that concern the time that user 36 was in high school.
identity verification parties 204, 206, 208 are members of verification group 216 (e.g., a group of college school friends) and are, therefore, well-suited for defining one or more verification items (e.g., included within verification items 56) that concern the time that user 36 was in college.
identity verification parties 210, 212 are members of verification group 218 (e.g., a group of current coworkers) and are, therefore, well-suited for defining one or more verification items (e.g., included within verification items 56) that concern the time that user 36 was at their current employer.

Once defined 100, user 36 may use identity verification process 10 to engage 102 each of identity verification parties 200, 202, 204, 206, 208, 210, 212 to generate verification items 56 for user 36 that may be configured to enable the verification of the identity of the user (e.g., user 36). The plurality of verification items (e.g., verification items 56) may include one or more of: at least one question & answer pair; at least one image item & answer pair; at least one video item & answer pair; and at least one audio item & answer pair.
Question & Answer Pairs: Examples of such question & answer pairs may include but are not limited to: Question “What was the nickname of user 36 in high school?” & Answer “Scooter” (for “high school” verification group 214); Question “Where did user 36 go for Spring Break in senior year of college?” & Answer “Cancun” (for “college” verification group 216); and Question “When did user 36 get promoted to Vice President?” & Answer “2012” (for “coworker” verification group 218).
Image Item & Answer Pairs: Examples of such image item & answer pairs may include but are not limited to: an Image of a high school girlfriend & Answer “Cindy” (for “high school” verification group 214); an Image of a Spring Break resort hotel & Answer “Azul Beach Resort Riviera Cancun” (for “college” verification group 216); and an Image of a coworker & Answer “Sam Smith” (for “coworker” verification group 218).
Video Item & Answer Pairs: Examples of such image item & answer pairs may include but are not limited to: a Video of a high school prom & Answer “Westbrook High Senior Prom 1992” (for “high school” verification group 214); a Video of a beach party & Answer “Spring Break Cancun 1996 (for “college” verification group 216); and a Video of a business presentation & Answer “Closing the Sale seminar 2001” (for “coworker” verification group 218).
Audio Item & Answer Pairs: Examples of such image item & answer pairs may include but are not limited to: Audio of a person singing & Answer “high school junior talent show” (for “high school” verification group 214); Audio of an academic presentation & Answer “senior project presentation” (for “college” verification group 216); and Audio of a business celebration & Answer “user 36 promoted to VP celebration” (for “coworker” verification group 218).

When engaging 102 each of identity verification parties 200, 202, 204, 206, 208, 210, 212 to generate verification items 56 for user 36, the plurality of verification items (e.g., verification items 56) may be generated in an iterative fashion between user 36 and each of identity verification parties 200, 202, 204, 206, 208, 210, 212.

For example and with respect to “high school” verification group 214, user 36 may use identity verification process 10 to engage 102 identity verification parties 200, 202 to:
ask verification parties 200, 202 the Question “What was the nickname of user 36 in high school?” and receive from verification parties 200, 202 the Answer “Scooter”;
show verification parties 200, 202 an Image of a high school girlfriend and receive from verification parties 200, 202 the Answer “Cindy”;
show verification parties 200, 202 a Video of a high school prom and receive from verification parties 200, 202 the Answer “Westbrook High Senior Prom 1992”; and
play verification parties 200, 202 Audio of a person singing” and receive from verification parties 200, 202 the Answer “high school junior talent show”.

Further and with respect to “college” verification group 216, user 36 may use identity verification process 10 to engage 102 identity verification parties 204, 206, 208 to:
ask verification parties 204, 206, 208 the Question “Where did user 36 go for Spring Break in senior year of college?” and receive from verification parties 204, 206, 208 the Answer “Cancun”;
show verification parties 204, 206, 208 an Image of a Spring Break resort hotel and receive from verification parties 204, 206, 208 the Answer “Azul Beach Resort Riviera Cancun”;
show verification parties 204, 206, 208 a Video of a beach party and receive from verification parties 204, 206, 208 the Answer “Spring Break Cancun 1996”; and
play verification parties 204, 206, 208 Audio of an academic presentation and receive from verification parties 204, 206, 208 the Answer “senior project presentation”.

Additionally and with respect to “coworker” verification group 218, user 36 may use identity verification process 10 to engage 102 identity verification parties 210, 212 to:
ask verification parties 210, 212 the Question “When did user 36 get promoted to Vice President?” and receive from verification parties 210, 212 the Answer “2012”;
show verification parties 210, 212 an Image of a coworker and receive from verification parties 210, 212 the Answer “Sam Smith”;
show verification parties 210, 212 a Video of a business presentation and receive from verification parties 210, 212 the Answer “Closing the Sale seminar 2001”; and
play verification parties 210, 212 Audio of a business celebration and receive from verification parties 210, 212 the Answer “user 36 promoted to VP celebration”.

Identity verification process 10 may allow the user (e.g., user 36) to become a member of the identity verification platform (e.g., verification platform 54) after achieving defined criteria. For example, identity verification process 10 may allow the user (e.g., user 36) to become a member of the identity verification platform (e.g., verification platform 54) upon: engaging a minimum-required number of identity verification parties (e.g., identity verification parties 200, 202, 204, 206, 208, 210, 212) and/or generating a minimum-required number of verification items (e.g., verification items 56) for the user (e.g., user 36).

Naturally, the greater the number of identity verification parties (e.g., identity verification parties 200, 202, 204, 206, 208, 210, 212) defined 100 and engaged 102 by user 36, the more likely it is that the identity of user 36 will be accurately verified (as it becomes a more arduous task for someone to spoof the identity of user 36). This is especially true when the identity of the verification parties (e.g., identity verification parties 200, 202, 204, 206, 208, 210, 212) are members of diverse verification groups (e.g., “high school” verification group 214 versus “college” verification group 216 versus “coworker” verification group 218). Additionally, the greater the number of verification items (e.g., verification items 56) generated by user 36, the more likely it is that the identity of user 36 will be accurately verified (as it becomes a more arduous task for someone to spoof the identity of user 36). This is especially true when the verification items (e.g., verification items 56) are generated via identity verification parties (e.g., identity verification parties 200, 202, 204, 206, 208, 210, 212) that are members of diverse verification groups (e.g., “high school” verification group 214 versus “college” verification group 216 versus “coworker” verification group 218).

Once identity verification process 10 allows the user (e.g., user 36) to become a member of the identity verification platform (e.g., verification platform 54), identity verification process 10 may notify 104 one or more financial institutions (e.g., financial institutions 222) that the user (e.g., user 36) is a member of the identity verification platform (e.g., verification platform 54) and that the one or more financial institutions (e.g., financial institutions 220) should only verify the identity of the user (e.g., user 36) (if the need arises) via the identity verification platform (e.g., verification platform 54). Such a notification may make it difficult for these financial institutions 222 to collect on fraudulent debt in the name of user 36 if that particular financial institution did not verify the identity user 36 via verification platform 54.

In the event that one of these financial institutions (e.g., financial institutions 222) needs to verify the identity of the user (e.g., user 36), identity verification process 10 may verify 106 the identity of the user (e.g., user 36) via one or more of the plurality of verification items (e.g., verification items 56). For example, assume that user 36 is applying for a credit card with a financial institution (e.g., one of financial institutions 222). Accordingly, the credit card application process executed by the financial institution (e.g., one of financial institutions 222) may interact with identity verification process 10 so that the identity of user 36 may be verified.

For example and when verifying 106 the identity of the user (e.g., user 36), identity verification process 10 may:
require 108 the user (e.g., user 36) to select an answer to a question & answer pair. For example, identity verification process 10 may require 108 user 36 to select the Answer “Scooter” (e.g., from a plurality of possible answers) to the Question “What was the nickname of user 36 in high school?”.
require 110 the user (e.g., user 36) to select an answer to an image item & answer pair. For example, identity verification process 10 may require 110 user 36 to select the Answer “Cindy” (e.g., from a plurality of possible answers) for the Image of a high school girlfriend.
require 112 the user (e.g., user 36) to select an answer to a video item & answer pair. For example, identity verification process 10 may require 112 user 36 to select the Answer “Westbrook High Senior Prom 1992” (e.g., from a plurality of possible answers) for the Video of a high school prom.
require 114 the user (e.g., user 36) to select an answer to an audio item & answer pair. For example, identity verification process 10 may require 114 user 36 to select the Answer “high school junior talent show” (e.g., from a plurality of possible answers) for the Audio of a person singing.
require 116 the user (e.g., user 36) to select a question to a question & answer pair. For example, identity verification process 10 may require 116 user 36 to select the Question “What was the nickname of user 36 in high school?” (e.g., from a plurality of possible questions) for the Answer “Scooter”.
require 118 the user (e.g., user 36) to select an image item to an image item & answer pair. For example, identity verification process 10 may require 118 user 36 to select the Image of a high school girlfriend (e.g., from a plurality of possible images) for the Answer “Cindy”.
require 120 the user (e.g., user 36) to select a video item to a video item & answer pair. For example, identity verification process 10 may require 120 user 36 to select the Video of a high school prom (e.g., from a plurality of possible videos) for the Answer “Westbrook High Senior Prom 1992”.
require 122 the user (e.g., user 36) to select an audio item to an audio item & answer pair. For example, identity verification process 10 may require 122 user 36 to select the Audio of a person singing (e.g., from a plurality of possible audio recordings) for the Answer “high school junior talent show”.

When verifying 106 the identity of the user (e.g., user 36), identity verification process 10 may:
require 124 the user (e.g., user 36) to provide an answer to a question & answer pair. For example, identity verification process 10 may require 124 user 36 to provide the Answer “Scooter” (e.g., by typing the answer) to the Question “What was the nickname of user 36 in high school?”
require 126 the user (e.g., user 36) to provide an answer to an image item & answer pair. For example, identity verification process 10 may require 126 user 36 to provide the Answer “Cindy” (e.g., by typing the answer) for the Image of a high school girlfriend.
require 128 the user (e.g., user 36) to provide an answer to a video item & answer pair. For example, identity verification process 10 may require 128 user 36 to provide the Answer “Westbrook High Senior Prom 1992” (e.g., by typing the answer) for the Video of a high school prom.
require 130 the user (e.g., user 36) to provide an answer to an audio item & answer pair. For example, identity verification process 10 may require 130 user 36 to provide the Answer “high school junior talent show” (e.g., by typing the answer) for the Audio of a person singing.

In the event that (in this example) a desired/required level of accuracy is achieved (e.g., 100%, 90%, etc.) with respect to the above-described verification items (e.g., verification items 56), the identity of user 36 may be verified by identity verification process 10 and, therefore, the financial institution (e.g., one of financial institutions 222) may provide user 36 with the credit card they are applying for.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
defining a plurality of identity verification parties for a user; and
engaging each of the plurality of identity verification parities to generate at least one verification item for the user, thus defining a plurality of verification items;
wherein the plurality of verification items are configured to enable the verification of the identity of the user.

2. The computer-implemented method of claim 1 wherein the plurality of identity verification parties are associated with the user via a social network.

3. The computer-implemented method of claim 1 wherein the plurality of identity verification parties are associated with the user via a communication program.

4. The computer-implemented method of claim 1 wherein the plurality of identity verification parties are members of two or more verification groups.

5. The computer-implemented method of claim 1 wherein the plurality of verification items includes one or more of:
at least one question & answer pair;
at least one image item & answer pair;
at least one video item & answer pair; and
at least one audio item & answer pair.

6. The computer-implemented method of claim 1 wherein the user becomes a member of an identity verification platform upon engaging a minimum-required number of identity verification parities and/or generating a minimum-required number of verification items for the user.

7. The computer-implemented method of claim 6 further comprising:
notifying one or more financial institutions that the user is a member of the identity verification platform and that the one or more financial institutions should only verify the identity of the user (if the need arises) via the identity verification platform.

8. The computer-implemented method of claim 1 further comprising:
verifying the identity of the user via one or more of the plurality of verification items.

9. The computer-implemented method of claim 8 wherein verifying the identity of the user includes one or more of:
requiring the user to select an answer to a question & answer pair;
requiring the user to select an answer to an image item & answer pair;
requiring the user to select an answer to a video item & answer pair;
requiring the user to select an answer to an audio item & answer pair;
requiring the user to select a question to a question & answer pair;
requiring the user to select an image item to an image item & answer pair;
requiring the user to select a video item to a video item & answer pair; and
requiring the user to select an audio item to an audio item & answer pair.

10. The computer-implemented method of claim 8 wherein verifying the identity of the user includes one or more of:
requiring the user to provide an answer to a question & answer pair;
requiring the user to provide an answer to an image item & answer pair;
requiring the user to provide an answer to a video item & answer pair; and
requiring the user to provide an answer to an audio item & answer pair.

11. A computer program product residing on a computer readable medium having a plurality of instructions stored thereon which, when executed by a processor, cause the processor to perform operations comprising:
defining a plurality of identity verification parties for a user; and
engaging each of the plurality of identity verification parities to generate at least one verification item for the user, thus defining a plurality of verification items;
wherein the plurality of verification items are configured to enable the verification of the identity of the user.

12. The computer program product of claim 11 wherein the plurality of identity verification parties are associated with the user via a social network.

13. The computer program product of claim 11 wherein the plurality of identity verification parties are associated with the user via a communication program.

14. The computer program product of claim 11 wherein the plurality of identity verification parties are members of two or more verification groups.

15. The computer program product of claim 11 wherein the plurality of verification items includes one or more of:
at least one question & answer pair;
at least one image item & answer pair;
at least one video item & answer pair; and
at least one audio item & answer pair.

16. The computer program product of claim 11 wherein the user becomes a member of an identity verification platform upon engaging a minimum-required number of identity verification parities and/or generating a minimum-required number of verification items for the user.

17. The computer program product of claim 16 further comprising:
notifying one or more financial institutions that the user is a member of the identity verification platform and that the one or more financial institutions should only verify the identity of the user (if the need arises) via the identity verification platform.

18. The computer program product of claim 11 further comprising:
verifying the identity of the user via one or more of the plurality of verification items.

19. The computer program product of claim 18 wherein verifying the identity of the user includes one or more of:
requiring the user to select an answer to a question & answer pair;
requiring the user to select an answer to an image item & answer pair;
requiring the user to select an answer to a video item & answer pair;
requiring the user to select an answer to an audio item & answer pair;
requiring the user to select a question to a question & answer pair;
requiring the user to select an image item to an image item & answer pair;
requiring the user to select a video item to a video item & answer pair; and
requiring the user to select an audio item to an audio item & answer pair.

20. The computer program product of claim 18 wherein verifying the identity of the user includes one or more of:
requiring the user to provide an answer to a question & answer pair;
requiring the user to provide an answer to an image item & answer pair;
requiring the user to provide an answer to a video item & answer pair; and
requiring the user to provide an answer to an audio item & answer pair.

21. A computing system including a processor and memory configured to perform operations comprising:
defining a plurality of identity verification parties for a user; and
engaging each of the plurality of identity verification parities to generate at least one verification item for the user, thus defining a plurality of verification items;
wherein the plurality of verification items are configured to enable the verification of the identity of the user.

22. The computing system of claim 21 wherein the plurality of identity verification parties are associated with the user via a social network.

23. The computing system of claim 21 wherein the plurality of identity verification parties are associated with the user via a communication program.

24. The computing system of claim 21 wherein the plurality of identity verification parties are members of two or more verification groups.

25. The computing system of claim 21 wherein the plurality of verification items includes one or more of:
at least one question & answer pair;
at least one image item & answer pair;
at least one video item & answer pair; and
at least one audio item & answer pair.

26. The computing system of claim 21 wherein the user becomes a member of an identity verification platform upon engaging a minimum-required number of identity verification parities and/or generating a minimum-required number of verification items for the user.

27. The computing system of claim 26 further comprising:
notifying one or more financial institutions that the user is a member of the identity verification platform and that the one or more financial institutions should only verify the identity of the user (if the need arises) via the identity verification platform.

28. The computing system of claim 21 further comprising:
verifying the identity of the user via one or more of the plurality of verification items.

29. The computing system of claim 28 wherein verifying the identity of the user includes one or more of:
requiring the user to select an answer to a question & answer pair;
requiring the user to select an answer to an image item & answer pair;
requiring the user to select an answer to a video item & answer pair;
requiring the user to select an answer to an audio item & answer pair;
requiring the user to select a question to a question & answer pair;
requiring the user to select an image item to an image item & answer pair;
requiring the user to select a video item to a video item & answer pair; and
requiring the user to select an audio item to an audio item & answer pair.

30. The computing system of claim 28 wherein verifying the identity of the user includes one or more of:
requiring the user to provide an answer to a question & answer pair;
requiring the user to provide an answer to an image item & answer pair;
requiring the user to provide an answer to a video item & answer pair; and
requiring the user to provide an answer to an audio item & answer pair.
